(19) United States
(12) Patent Application Publication
(10) Pub. No.: US 2024/0292794 A1
(43) Pub. Date: Sep. 5, 2024

(54) WATER STORAGE SYSTEM

(71) Applicant: DeepRoot Green Infrastructure, LLC, San Francisco, CA (US)

(72) Inventors: Charles Graham Ray, Mill Valley, CA (US); Patrick Brien Greeley, Hopkins, MN (US); Jeffrey Shawn Freedberg, Kensington, CA (US); John Joseph Cogger, Santa Ana, CA (US)

(73) Assignee: DeepRoot Green Infrastructure, LLC, San Francisco, CA (US)

(21) Appl. No.: 18/662,475

(22) Filed: May 13, 2024

Related U.S. Application Data
(63) Continuation-in-part of application No. 18/315,141, filed on May 10, 2023.
Application No. 18/315,141 is a continuation-in-part of application No. 18/100,266, filed on Jan. 23, 2023.

(51) Int. Cl. A01G 27/06; E03F 1/00

(52) U.S. Cl. CPC A01G 27/06; E03F 1/005

(57) ABSTRACT

The present disclosure describes a an integrated tree watering and support system. In particular, the disclosed tree watering system can include a fill tube and a configuration of water storage units. The system can better promote hydration and aeration of tree roots, allow for versatile watering conditions, and provide stability and support to the tree. The fill tube can receive rainwater, hose water, or even water from alternative irrigation systems and can cater to varying environmental conditions. The water storage unit can deliver water and air directly to the root ball of the tree, enabling increased root health and growth. Moreover, by placing the root ball of the tree on top of the water storage unit, stability and support are provided to the tree, which can prevent subsidence and enhance overall tree stability.

### CROSS-REFERENCE TO RELATED APPLICATIONS

This application is a continuation-in-part of and claims priority to U.S. application Ser. No. 18/315,141, filed May 10, 2023, which is a continuation-in-part of U.S. application Ser. No. 18/100,266, filed Jan. 23, 2023, which are herein incorporated by reference in their entireties.

### BACKGROUND OF THE DISCLOSURE

Traditional stormwater management techniques often involve centralized systems that are buried deep underground. However, these systems come with certain shortcomings. For example, there is limited availability of this space. Moreover, there are environmental concerns with these approaches in urban environments that have limited space for green infrastructure.

In addition, there is a growing awareness of the importance of sustainable water management practices, and one critical aspect of this is the efficient watering of trees. Existing tree watering systems typically consist of drip irrigation or surface watering techniques. Drip irrigation systems, including watering bags and rings, deliver water directly to the base of the tree, minimizing water loss through evaporation and runoff. However, above ground bags are unsightly and prone to vandalism. Surface watering methods, on the other hand, involve the application of water to the soil surrounding the tree, which often results in over or underwatering, and requires considerable resources to water on a timely basis by hand. Another issue with both techniques is the inability to corral stormwater and reuse it for irrigation.

### SUMMARY OF THE DISCLOSURE

According to one aspect of the present disclosure, a watering system for watering a tree can include one or more vertically stacked water storage units. Each storage unit can include an outer shell with a first side which can include a first plurality of openings and a second side adjacent the first side which can include a second plurality of openings, wherein a top water storage unit can include a water storage lid, wherein at least one of the first side or second side can include a plurality of secondary openings, wherein each secondary opening is between an opening and a corner of the outer shell. The watering system can also include a fill tube which can include a first end and a second end; the first end can reside above a ground level and the second end can reside in an opening of the first or second plurality of openings of a water storage unit. The fill tube can be configured to feed water into the one or more water storage units. The tree can reside on top of the one or more vertically stacked water storage units.

In some embodiments, the outer shell can include a third side which can include a third plurality of openings, wherein the third side is opposite the first side and the third plurality of openings are aligned with the first plurality of openings. The outer shell can include a fourth side which can include a fourth plurality of openings, wherein the fourth side is opposite the second side and the fourth plurality of openings are aligned with the second plurality of openings. In some embodiments, a root ball of the tree can reside on top of the one or more vertically stacked water storage units.

In some embodiments, the one or more vertically stacked water storage units can include two water storage units. In some embodiments, the one or more vertically stacked water storage units can be wrapped in a geotextile material. In some embodiments, the one or more vertically stacked water storage units can be surrounded by bio-retention soil. In some embodiments, the fill tube can be connected to and receive water from at least one of a rainwater harvesting system, a hose, or an irrigation system. In some embodiments, the watering system can include one or more soil moisture sensors configured to measure moisture levels of soil surrounding the one or more water storage units. In some embodiments, each water storage unit can include a first set of cross-bodies spanning a width of the outer shell; and a second set of cross-bodies spanning a length of the outer shell and intersecting the first set of cross-bodies. In some embodiments, each water storage unit can include a plurality of vertical pillars, the pillars supporting intersection points of the first and second sets of cross-bodies.

According to another aspect of the present disclosure, a drainage system can include a one or more water storage units; each storage unit can include an outer shell with a first side which can include a first plurality of openings and a second side adjacent the first side which can include a second plurality of openings, wherein a top water storage unit can include a water storage lid, wherein at least one of the first side or second side can include a plurality of secondary openings, wherein each secondary opening is between an opening and a corner of the outer shell. The drainage system can also include a catch basin and an inlet pipe which can include a first end and a second end. The first end can reside in an opening of the first or second plurality of openings of a water storage unit and the second end can be positioned to redirect water from the plurality of water storage units to the catch basin. The plurality of water storage units can reside underneath a hardscape.

In some embodiments, the outer shell can include a third side which can include a third plurality of openings, wherein the third side is opposite the first side and the third plurality of openings are aligned with the first plurality of openings. The outer shell can include a fourth side which can include a fourth plurality of openings, wherein the fourth side is opposite the second side and the fourth plurality of openings are aligned with the second plurality of openings. In some embodiments, the one or more water storage units can include a plurality of stacks of water storage units. In some embodiments, each stack of water storage units can include two vertically stacked water storage units. In some embodiments, the one or more water storage units can be wrapped in a geotextile material.

In some embodiments, the one or more water storage units can be surrounded by bio-retention soil and a compact backfill. In some embodiments, the watering system can include one or more soil moisture sensors configured to measure moisture levels of soil surrounding the one or more water storage units. In some embodiments, each water storage unit can include a first set of cross-bodies spanning a width of the outer shell; and a second set of cross-bodies spanning a length of the outer shell and intersecting the first set of cross-bodies. In some embodiments, each water storage unit can include a plurality of vertical pillars, the pillars supporting intersection points of the first and second sets of cross-bodies.

### BRIEF DESCRIPTION OF THE FIGURES

FIG. 1A shows a perspective view of a water storage unit according to some embodiments of the present disclosure.

FIG. 1B shows a top view of a water storage unit according to some embodiments of the present disclosure.

FIG. 1C shows a side view of a water storage unit according to some embodiments of the present disclosure.

FIG. 1D shows a male connection mechanism of a water storage unit according to some embodiments of the present disclosure.

FIG. 2A shows a perspective view of a water storage lid according to some embodiments of the present disclosure.

FIGS. 2B and 2C show perforations and a female connection mechanism of a water storage lid according to some embodiments of the present disclosure.

FIG. 2D shows a top view of a water storage lid according to some embodiments of the present disclosure.

FIG. 2E shows a bottom view of a water storage lid according to some embodiments of the present disclosure.

FIG. 2F shows a side view of a water storage lid according to some embodiments of the present disclosure.

FIG. 3A shows a perspective view of a water storage unit and lid combination according to some embodiments of the present disclosure.

FIG. 3B shows a side view of a water storage unit and lid combination according to some embodiments of the present disclosure.

FIG. 4A shows a perspective view of a water storage unit assembly according to some embodiments of the present disclosure.

FIG. 4B shows a side view of a water storage unit assembly according to some embodiments of the present disclosure.

FIG. 5A shows a perspective view of another water storage unit assembly according to some embodiments of the present disclosure.

FIG. 5B shows a side view of another water storage unit assembly according to some embodiments of the present disclosure.

FIG. 6A shows a perspective view of another water storage unit assembly according to some embodiments of the present disclosure.

FIG. 6B shows a zoomed-in view of another water storage unit assembly according to some embodiments of the present disclosure.

FIG. 7. shows a water storage unit assembly with flow restrictors according to some embodiments of the present disclosure.

FIG. 8A shows a perspective view of a flow restrictor assembly according to some embodiments of the present disclosure.

FIG. 8B shows an exploded view of a flow restrictor assembly according to some embodiments of the present disclosure.

FIG. 8C shows a back perspective view of a first configuration of a flow restrictor assembly according to some embodiments of the present disclosure.

FIG. 8D shows a back perspective view of a second configuration of a flow restrictor assembly according to some embodiments of the present disclosure.

FIG. 9 shows a perspective view of another flow restrictor according to some embodiments of the present disclosure.

FIG. 10A shows a perspective view of another embodiment of a water storage unit according to some embodiments of the present disclosure.

FIG. 10B shows a top perspective view of another embodiment of a water storage unit according to some embodiments of the present disclosure.

FIG. 11 shows a perspective view of another embodiment of a water storage unit and lid combination according to some embodiments of the present disclosure.

FIG. 12 shows an example tree watering system according to some embodiments of the present disclosure.

FIG. 13 shows an example tree watering process according to some embodiments of the present disclosure.

FIG. 14 shows an example drainage system according to some embodiments of the present disclosure.

FIG. 15 shows an example drainage process according to some embodiments of the present disclosure.

### DESCRIPTION

The following detailed description is merely exemplary in nature and is not intended to limit the invention or the applications of its use.

Embodiments of the present disclosure relate to an integrated tree watering and support system. In particular, the disclosed tree watering system can include a fill tube and a configuration of water storage units. The system can better promote hydration and aeration of tree roots, allow for versatile watering conditions, and provide stability and support to the tree. The fill tube can receive rainwater, hose water, or even water from alternative irrigation systems and can cater to varying environmental conditions. The water storage unit can deliver water and air directly to the root ball of the tree, enabling increased root health and growth. Moreover, by placing the root ball of the tree on top of the water storage unit, stability and support are provided to the tree, which can prevent subsidence and enhance overall tree stability.

The disclosed tree watering system can address the shortcomings of existing tree watering systems discussed above by specifically supporting the base of the tree root ball and efficiently delivering water for irrigation purposes. By placing the stormwater capture and reuse storage below ground, the above ground issues can be eliminated. In addition, the disclosed system can also provide a long-term storage system that enables re-use of stormwater for tree watering, promoting the establishment and growth of healthy urban trees.

Embodiments of the present disclosure also relate to a drainage system that can reduce excavation requirements during implementation and keep stormwater onsite to mimic natural predevelopment conditions. In particular, the disclosed drainage system can be employed as a drainage tool in conjunction with certain structures, such as sidewalks and grass boulevards. The disclosed drainage system can offer various advantages. First, the disclosed drainage system can increase available drainage areas, which can facilitate onsite stormwater management and reduce reliance on centralized drainage systems. Second, the disclosed drainage system can integrate with inlet pipes and catch basins to capture sidewalk and street stormwater, which can ensure compliance with post-development stormwater regulations and goals. Third, the disclosed drainage system can mimic natural pre-development site conditions, which can enhance stormwater absorption and infiltration capabilities to mitigate runoff and pollution. Fourth, the disclosed drainage system can be implemented with reduced excavation, which can decrease disruption to existing infrastructure and increase flexible storage and reuse opportunities.

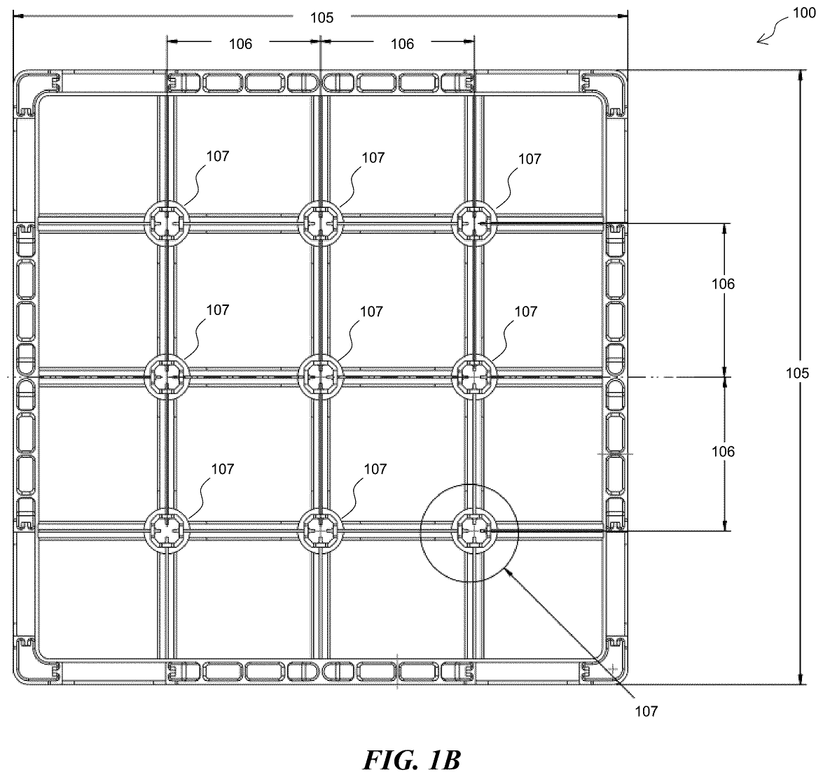

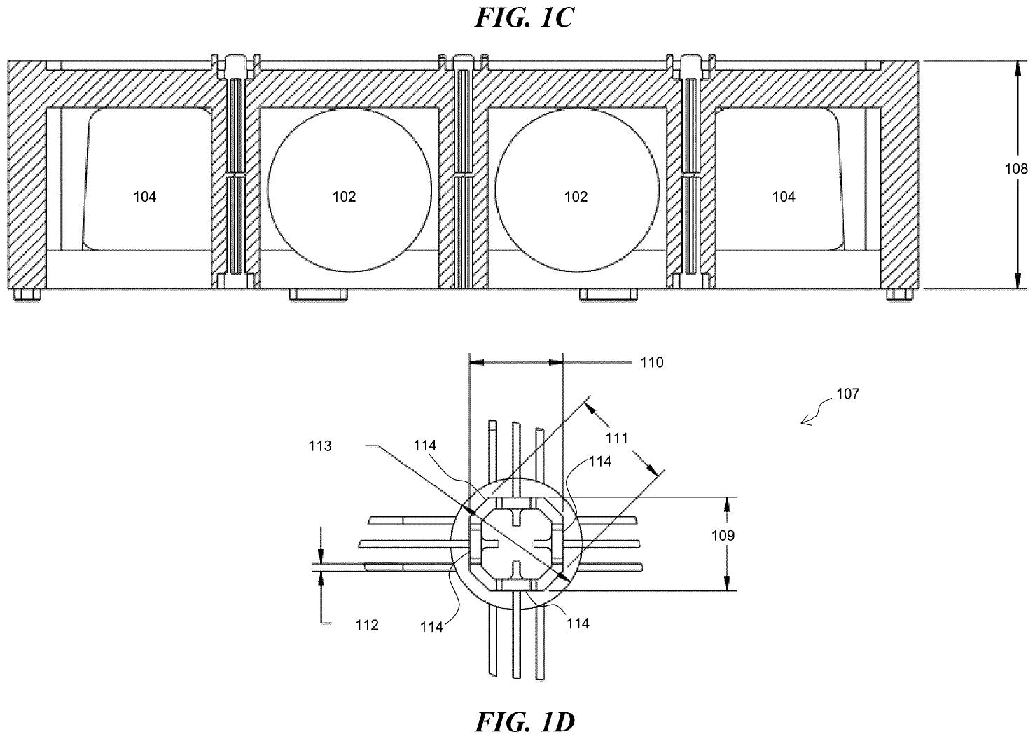

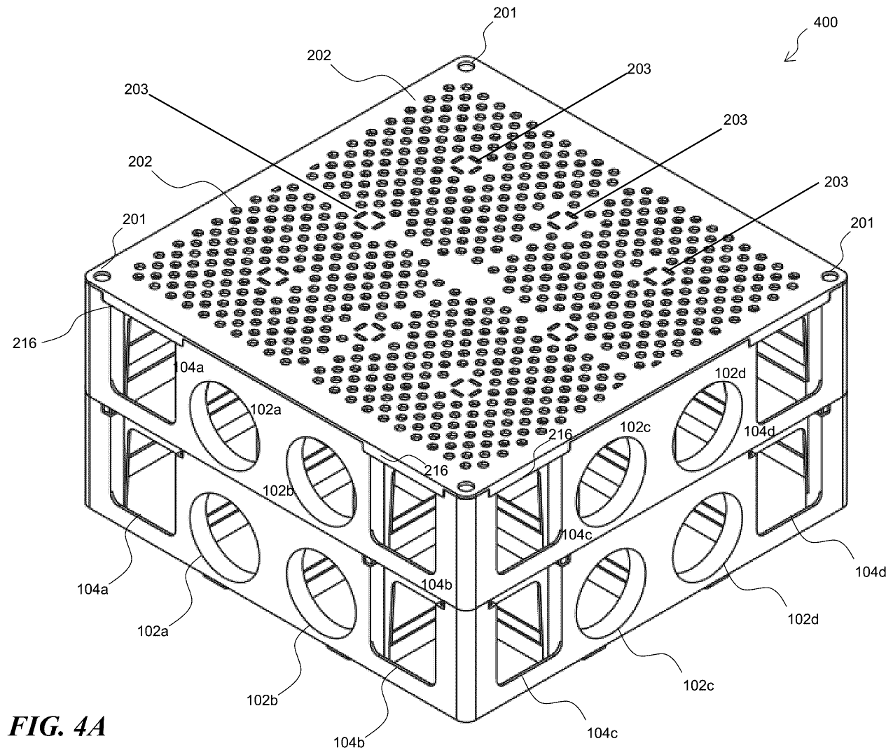

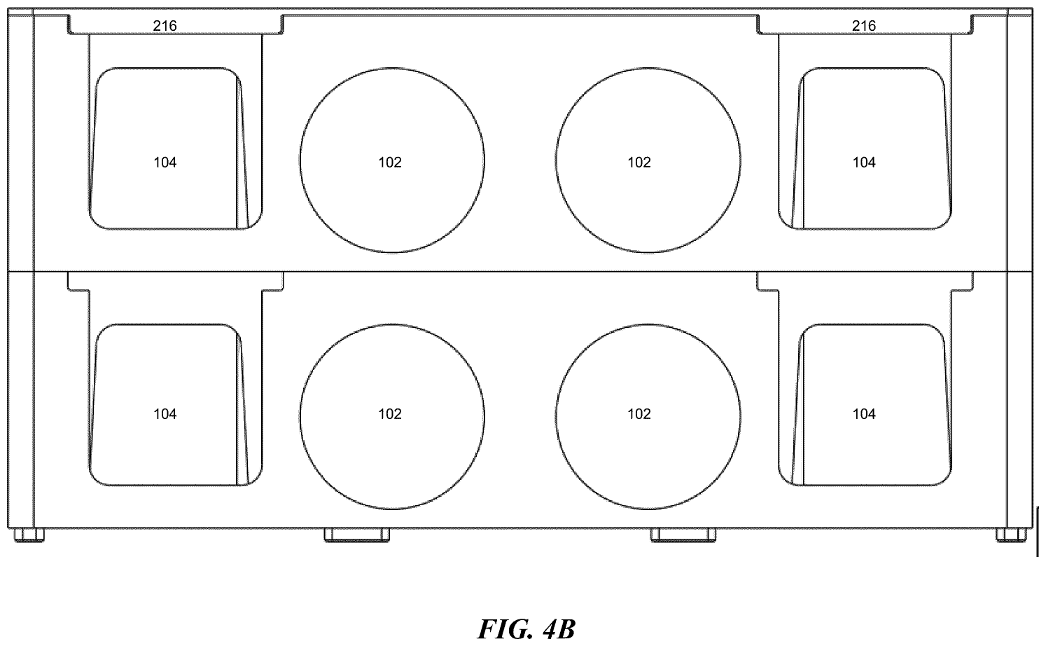

FIG. 1A shows a perspective view of a water storage unit 100 according to some embodiments of the present disclosure. A water storage unit 100 can be used as a base or building block to form a water storage assembly (see FIGS. 4A-6B). The water storage unit 100 includes an outer shell 101. In addition, the water storage unit 100 can include various openings 102a-h (herein referred to as an “opening 102” generally or “openings 102” collectively) in the outer shell 101, which are configured to allow various piping, cables, lines, etc. to pass through them, substantially increasing the size and quantity of lines that can run through the unit 100, thus increasing the flexibility and efficiency in which the unit 100 can operate within the surrounding infrastructure. In some embodiments, the water storage unit 100 can include a plurality of openings 102 on each side of the outer shell 101, where the openings 102 of opposite sides are co-radial or concentric but in different planes. For example, the water storage unit 100 of FIG. 1A includes two openings 102 on each side of the outer shell 101, where openings 102a-b are concentric with openings 102g-h and openings 102c-d are concentric with openings 102e-f. In addition, the water storage unit 100 includes various cross-bodies 103a-f (herein referred to as a “cross-body 103” generally or “cross-bodies 103” collectively). The cross-bodies 103 can connect opposite sides of the outer shell 101 (i.e., spanning the width of the outer shell 101). In addition, when the water storage unit 100 includes multiple sets of parallel cross-bodies 103, the two sets can intersect perpendicularly. In some embodiments, each opening 102 can reside between two cross-bodies 103. In some embodiments, the opening 102 can reside midway between the two cross-bodies 103. At each intersection of cross-bodies 103, a vertical pillar can support the intersection point. These pillars and the cross-bodies 103 can form a sort of lattice within the interior of the water storage unit 100. In some embodiments, the water storage unit 100 can also include one or more secondary openings 104 on each side of the outer shell 101. For example, in FIG. 1A, each side includes a secondary opening 104 that is between an opening 102 and the nearest corner of the outer shell 101. In some embodiments, secondary openings 104 are optional, but may reduce the amount of required material to build the water storage unit 100 while maintaining sufficient structural integrity to support a hardscape and any weight thereon. In some embodiments, the secondary openings 104 can be approximately rectangular in shape, although this is not limiting.

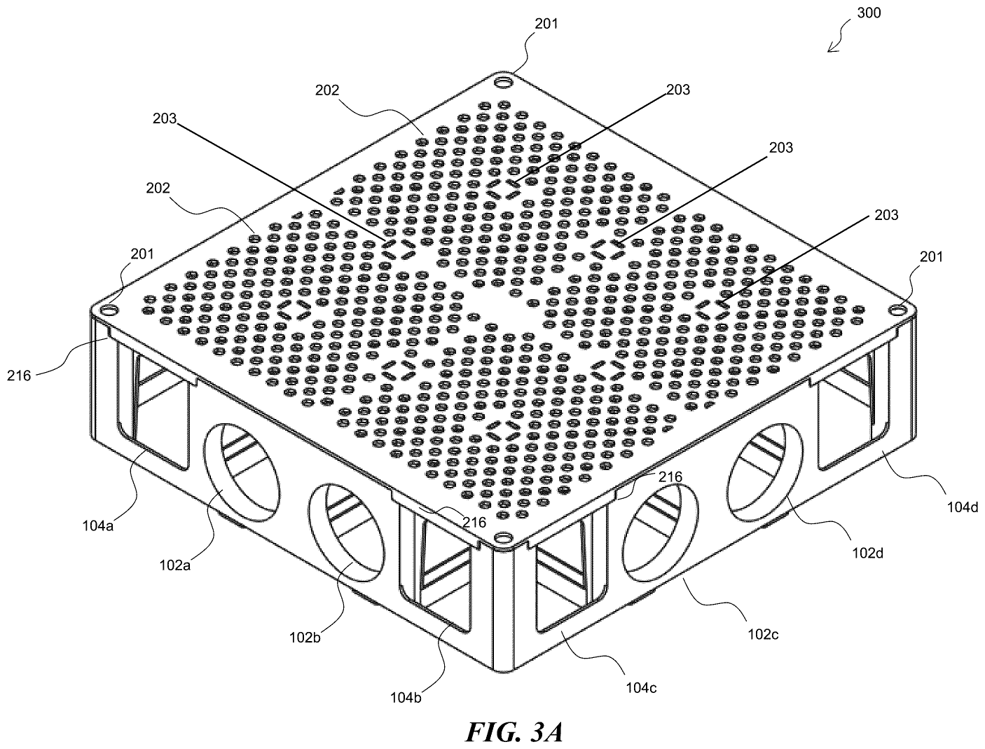

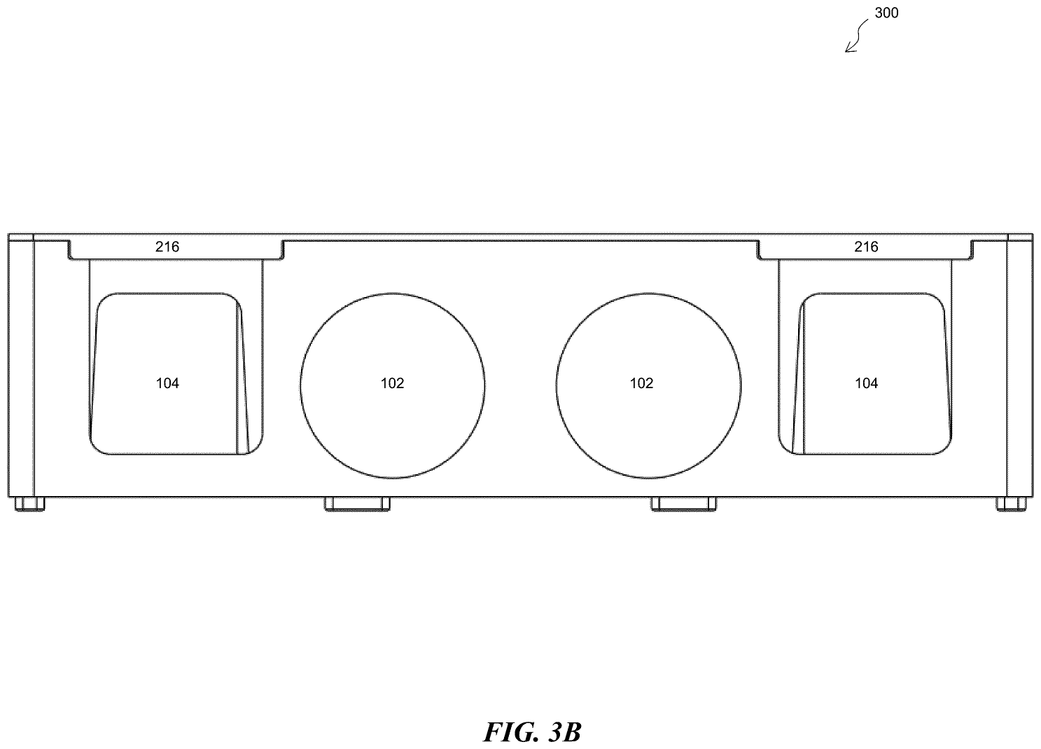

FIG. 1B shows a top view of a water storage unit 100 according to some embodiments of the present disclosure. The water storage unit 100 includes a width 105 and length 105, which are equal in this embodiment and can be about 600 mm. In other embodiments, the water storage unit 100 may not be a square and the width and length may not be equal. In addition, the water storage unit 100 includes a distance 106 between each cross-body 103. In some embodiments, the distance 106 can be about 150 mm. It is important to note that, while the distances 106 in the disclosed embodiments are equal, this is not a requirement. In addition, the water storage unit 100 includes a plurality of intersection points that include a male connection mechanism 107. The male connection mechanisms 107 can be configured to attach to a lid (see FIGS. 3A-3B) or to other water storage units 100. Additional details regarding the male connection mechanism 107 are discussed in relation to FIG. 1D.

FIG. 1C shows a side view of a water storage unit 100 according to some embodiments of the present disclosure. From the side, the two openings 102 and the two secondary openings 104 are visible. Water storage unit 100 can have a height 108, which is about 150 mm. In some embodiments, the openings 102 can have a diameter of about 128 mm or less.

FIG. 1D shows a male connection mechanism 107 of a water storage unit 100 according to some embodiments of the present disclosure. In some embodiments, the male connection mechanism 107 can include four prongs 114. The prongs 114 can be used to attach the water storage unit 100 to other a lid or other water storage units. In addition, the male connection mechanism 107 can include a length 109 and a width 110. In some embodiments, the length 109 and width 110 can be equal and can be about 32 mm. In addition, the male connection mechanism 107 can include a diagonal width 111, which can be about 36 mm. The male connection mechanism 107 can also include a thickness 112 of about 2.5 mm and a diameter 113 of about 45 mm.

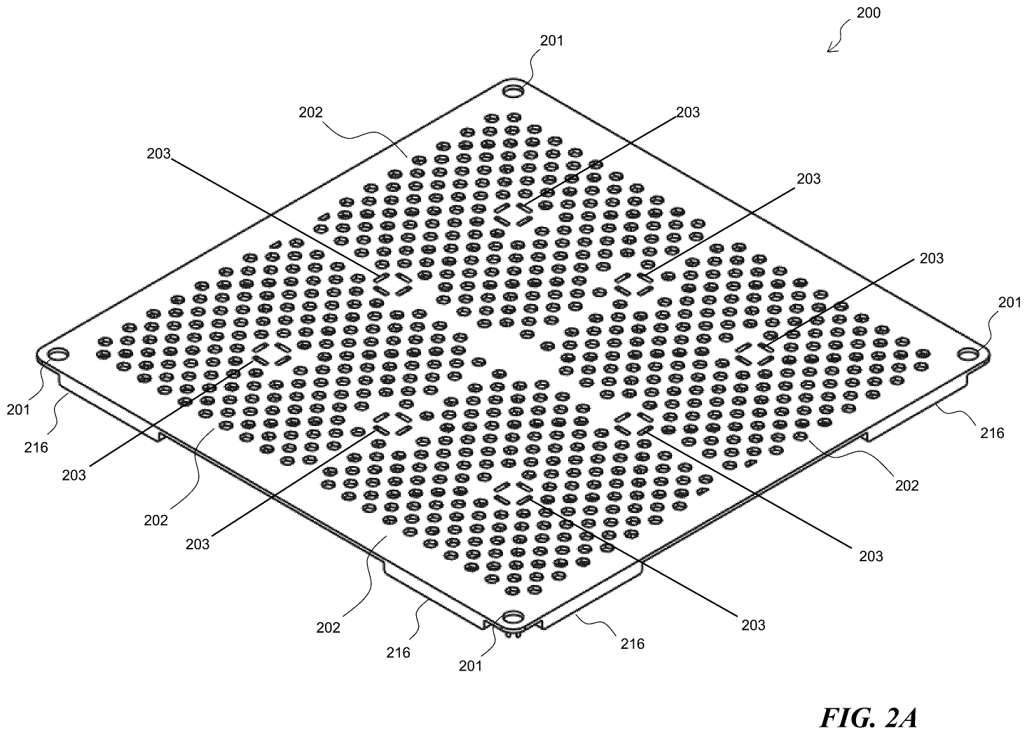

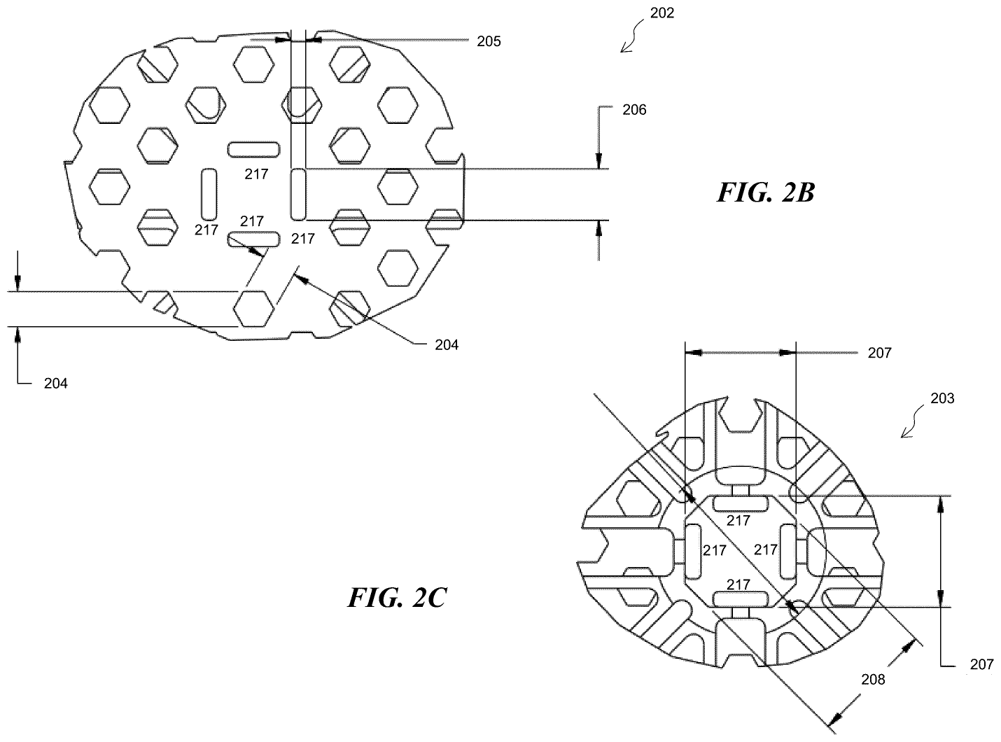

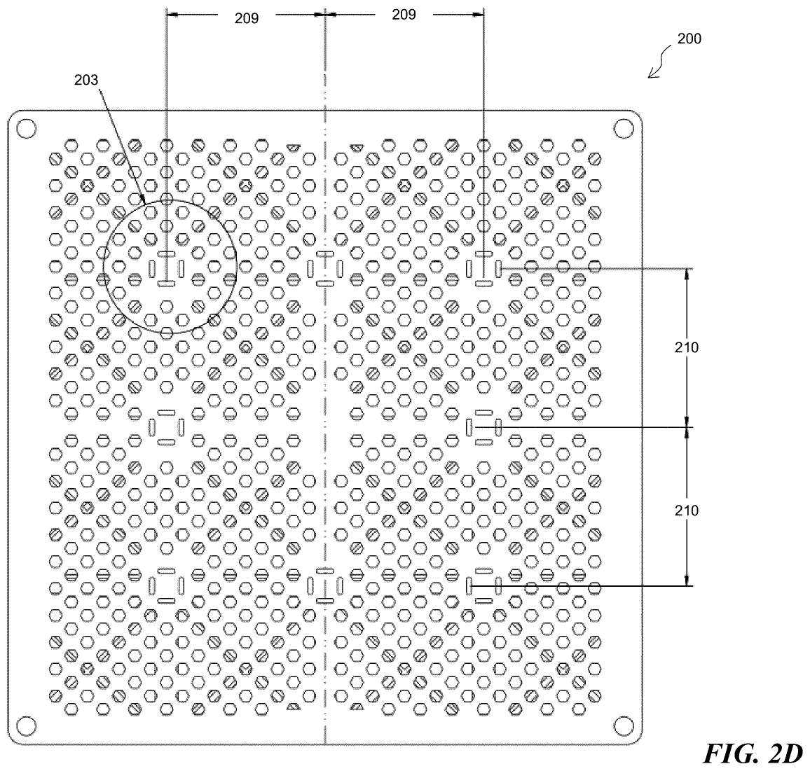

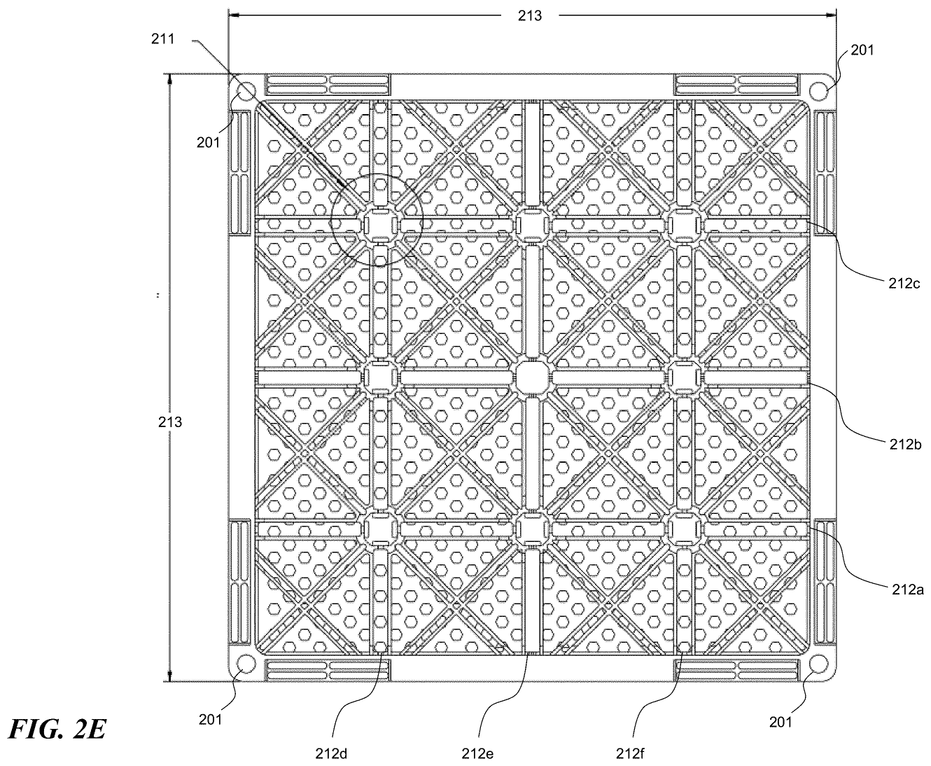

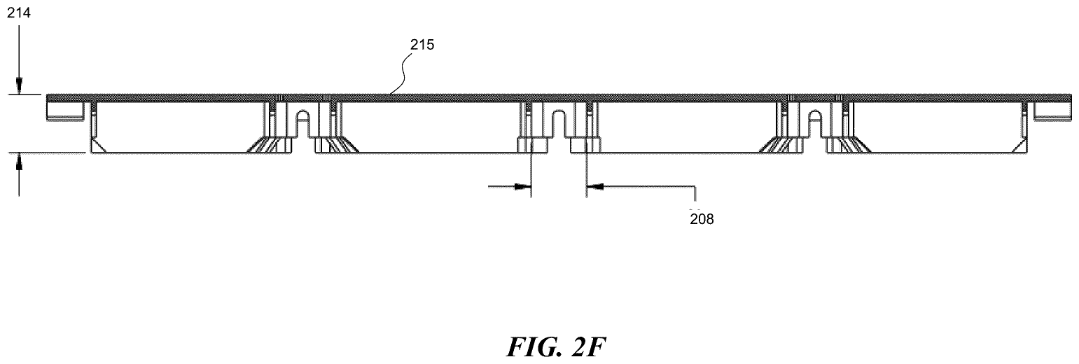

FIG. 2A shows a perspective view of a water storage lid 200 according to some embodiments of the present disclosure. In some embodiments, the water storage lid 200 can include four corner openings 201, which can be used to accommodate the insertion of a wicking material to draw water from the bottom of the system to the top where it can be used to support plant growth. In addition, the water storage lid 200 can be perforated to allow for water to easily flow through into the storage unit compartment but maintain structural integrity sufficient to support a hardscape. In some embodiments, the water storage lid 200 can include patterns of perforations, such as the four quadrants 202, where each quadrant 202 includes a grid of perforations. Additional details of the perforations are discussed in relation to FIG. 2B. In addition, the water storage lid 200 includes a plurality of female connection mechanisms 203, which are configured to receive and attach to the male connection mechanisms 107 of water storage unit 100. Additional details of the female connection mechanism 203 are discussed in FIG. 2C. In some embodiments, the water storage lid 200 further includes a plurality of flaps 216 that assist in the connection to a water storage unit 100.

FIGS. 2B and 2C show perforations and a female connection mechanism of a water storage lid 200 according to some embodiments of the present disclosure. FIG. 2B is a zoomed-in view of a quadrant 202 of perforations from water storage lid 200. In some embodiments, the perforations can be hexagonally-shaped, although this is not limiting in nature and various shapes could be possible, such as a circle, square, octagon, etc. In FIG. 2B, where the perforations are hexagonal, the dimensions can include an equal height and width 204 of an 11 mm type hex. In addition, the female attachment mechanism 203 includes widths 207, which can be about 32.5 mm, although they are not required to be equal. In addition, the female attachment mechanism 203 include a diagonal width 208, which can be about 36.25 mm. Finally, the female attachment mechanism 203 includes four slots 217 which are configured to receive the prongs 114 of the male attachment mechanism 107. In some embodiments, the number of female attachment mechanisms 203 can correspond to the number of intersections of cross-bodies 103 in a water storage unit 100. In some embodiments, the slots can have a width 205 of about 4.64 mm and a length 206 of about 16 mm.

FIG. 2D shows a top view of a water storage lid 200 according to some embodiments of the present disclosure. The top view illustrates the female attachment mechanisms 203. In addition, the water storage lid 200 includes distances 209 and 210 between the female attachment mechanisms 203. In some embodiments, the distances 209 and 210 can be about 150 mm.

FIG. 2E shows a bottom view of a water storage lid 200 according to some embodiments of the present disclosure. The bottom of the water storage lid 200 includes cross-beams 212 that can add structural integrity to the system. In addition, the cross-beams 212 can intersect at the bottom 211 of the female attachment mechanisms. In some embodiments, the width and length 213 of the water storage lid 200 can be the same and can be about 600 mm.

FIG. 2F shows a side view of a water storage lid 200 according to some embodiments of the present disclosure. The water storage lid can include a top portion 215, which includes the various perforations and female attachment mechanisms 203 discussed in relation to FIGS. 2A-2E. In some embodiments, a width 208 of the female attachment mechanisms 203 can be about 32.5 mm. In addition, the overall thickness 214 of the water storage lid 200 can be about 34 mm.

FIG. 3A shows a perspective view of a water storage unit and lid combination 300 according to some embodiments of the present disclosure. The combination 300 includes a water storage unit 100 attached to a water storage lid 200, where the male attachment mechanisms 107 of the water storage unit 100 are connected to the female attachment mechanisms 203 of the water storage lid 200. In particular, the prongs 114 have been inserted into the slots 217 (not shown). In addition, the flaps 216 reside around the secondary openings 104 and prevent the water storage unit 100 from moving significantly in any direction, providing added stability to the combination 300. FIG. 3B shows a side view of a water storage unit and lid combination 300 according to some embodiments of the present disclosure. The flaps 216 hang over the top edge of the water storage unit 100, above the secondary openings 104.

FIG. 4A shows a perspective view of a water storage unit assembly 400 according to some embodiments of the present disclosure. The water storage unit assembly 400 is an example of stacking two water storage units 100 on top of each other and covering the assembly with a water storage lid 200. The water storage lid 200 and the top water storage unit can be connected in the same manner as described in relation to FIG. 3A. In addition, the top and bottom water storage units are connected via a similar mechanism. FIG. 4B shows a side view of a water storage unit assembly 400 according to some embodiments of the present disclosure. The flaps 216 of the water storage lid 200 is aligned with both sets of secondary openings 104.

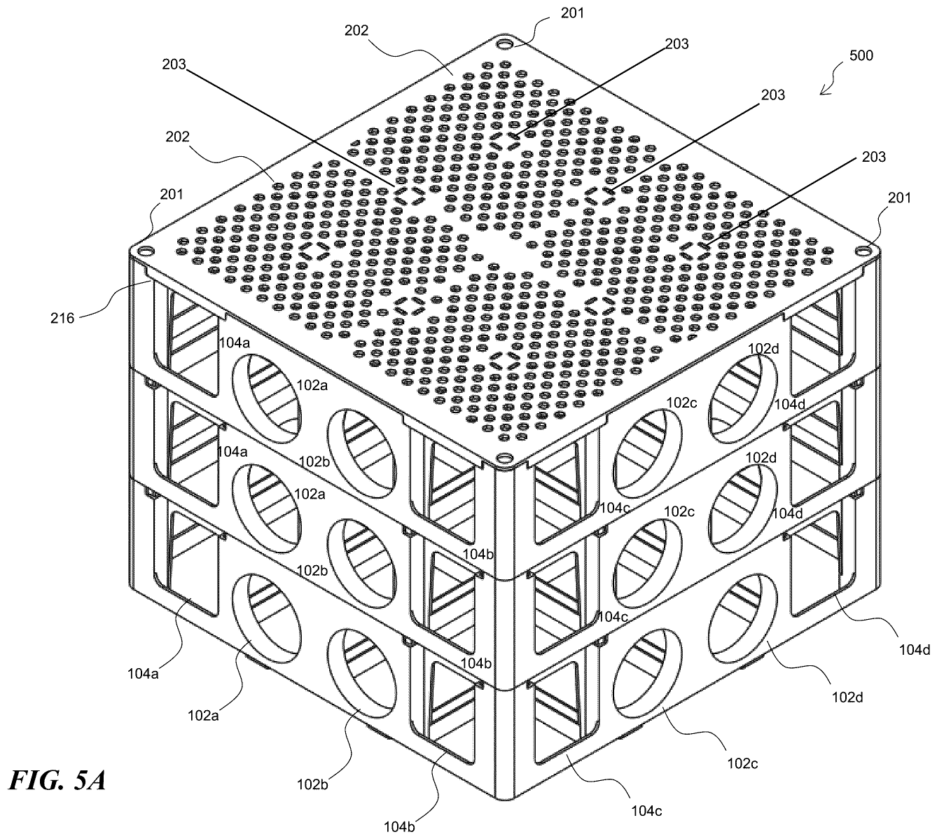

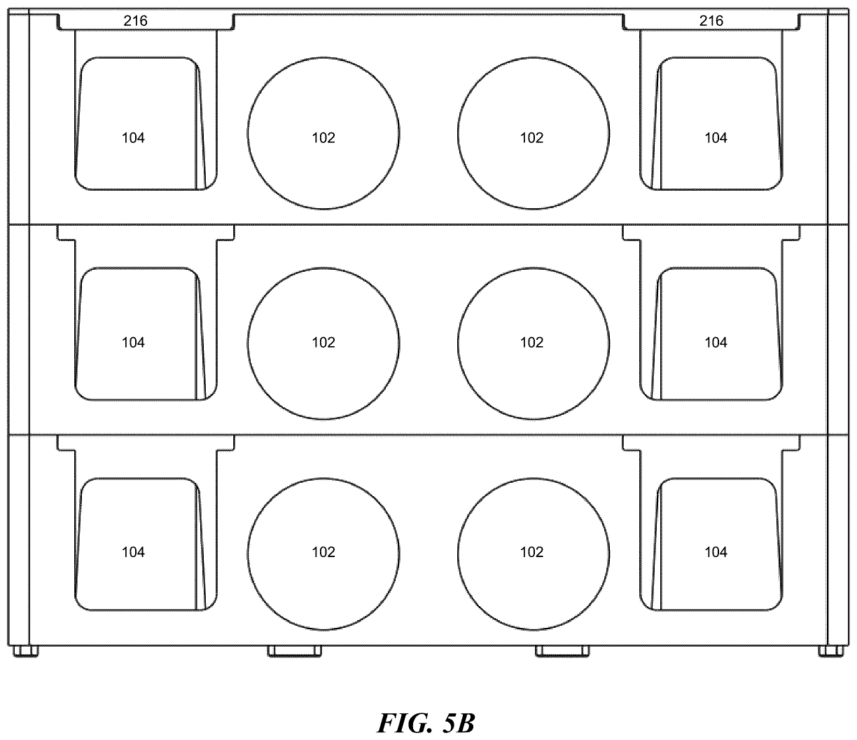

FIG. 5A shows a perspective view of another water storage unit assembly 500 according to some embodiments of the present disclosure. The water storage unit assembly 500 is an example of stacking three water storage units 100 on top of each other and covering the assembly with a water storage lid 200. The water storage lid 200 and the top water storage unit can be connected in the same manner as described in relation to FIG. 3A. In addition, the remaining water storage units 100 are connected via a similar mechanism. FIG. 5B shows a side view of another water storage unit assembly 500 according to some embodiments of the present disclosure. The flaps 216 of the water storage lid 200 is aligned with both sets of secondary openings 104.

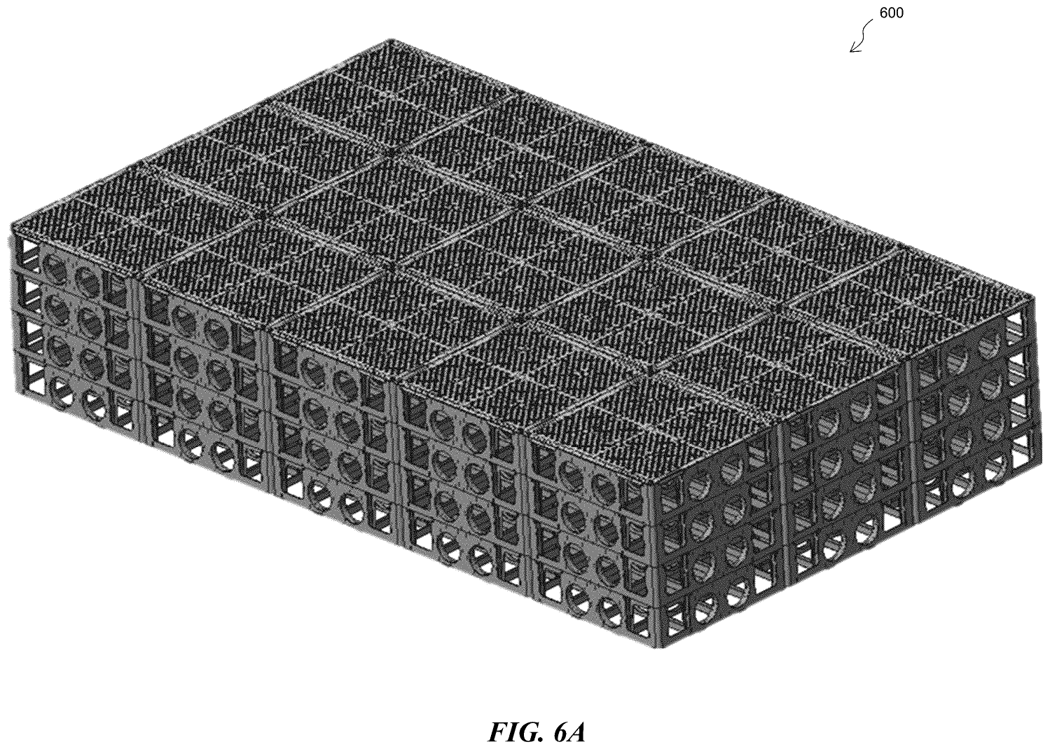

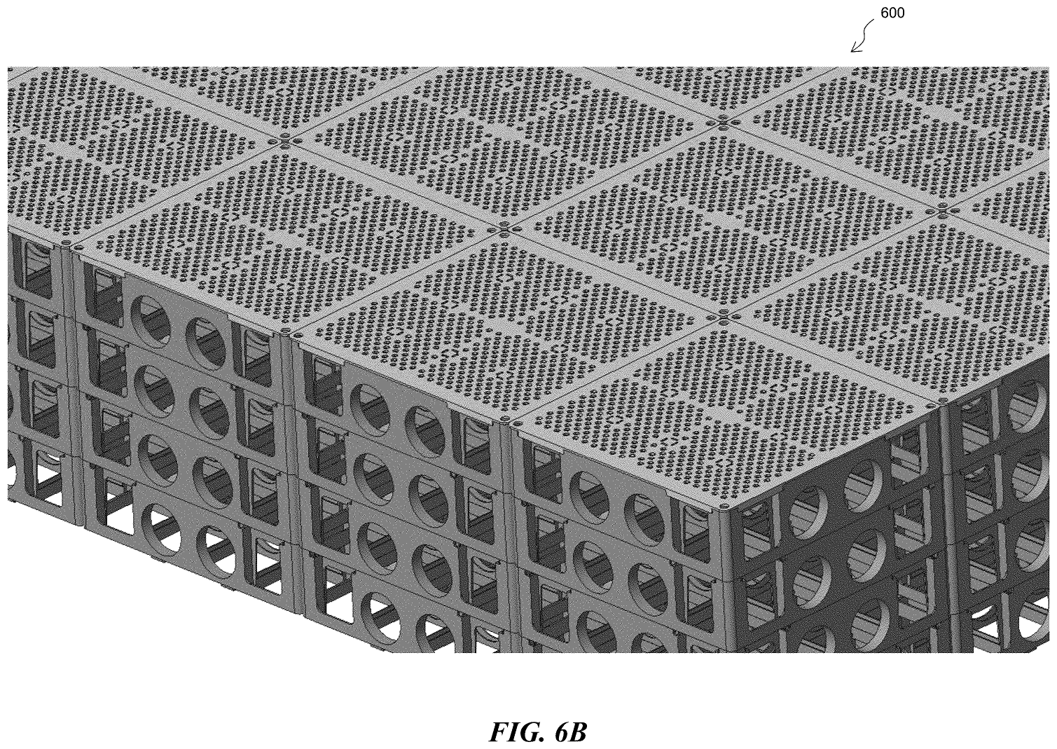

FIG. 6A shows a perspective view of another water storage unit assembly 600 according to some embodiments of the present disclosure. The assembly 600 includes fifteen stacks of quadruple stacks of water storage units 100, each covered by a water storage lid 200. The assembly 600 therefore includes fifteen water storage lids 200 and sixty water storage units 100. FIG. 6B shows a zoomed-in view of another water storage unit assembly 600 according to some embodiments of the present disclosure.

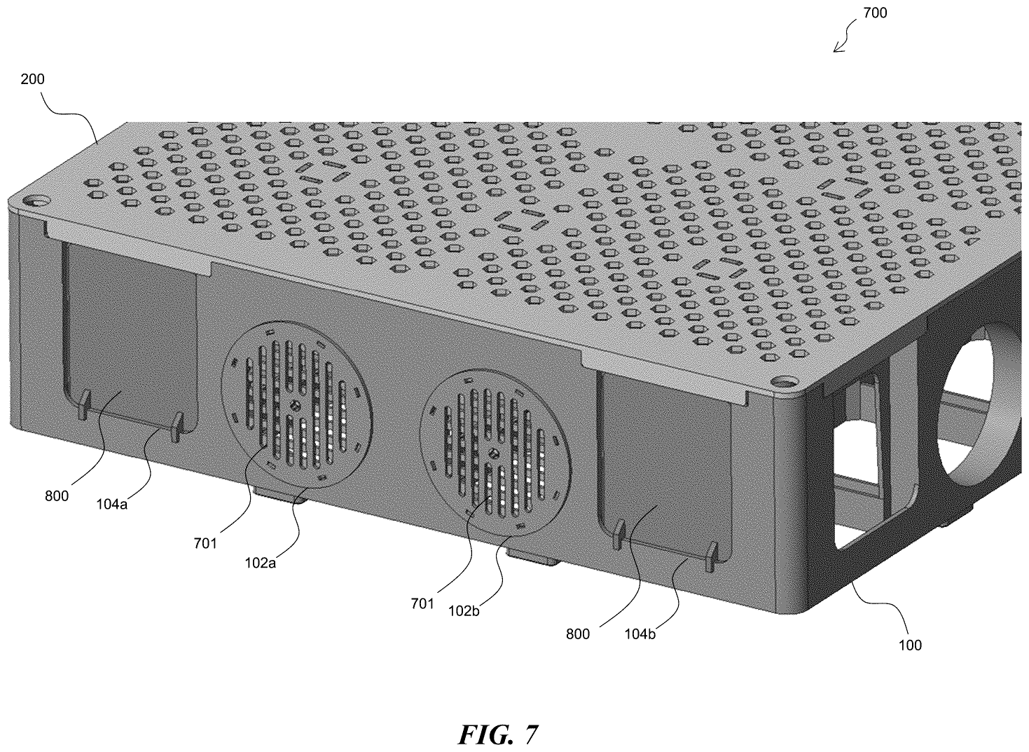

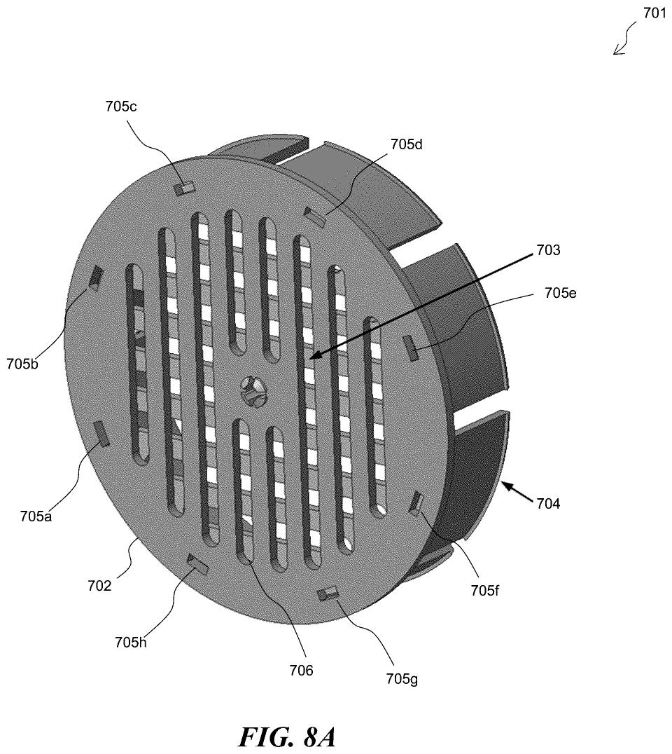

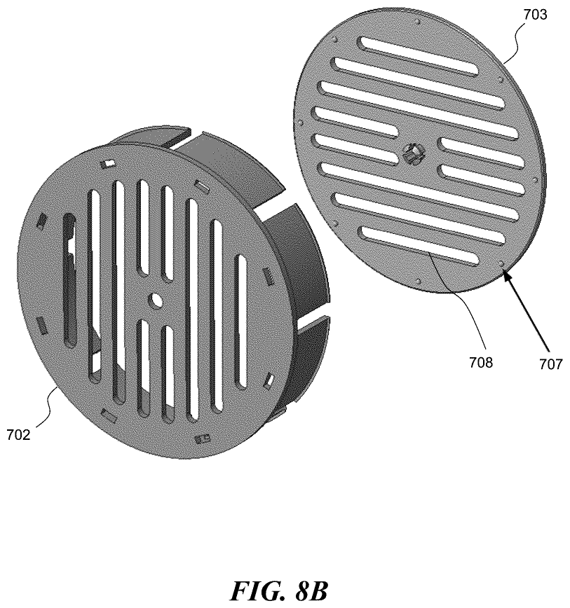

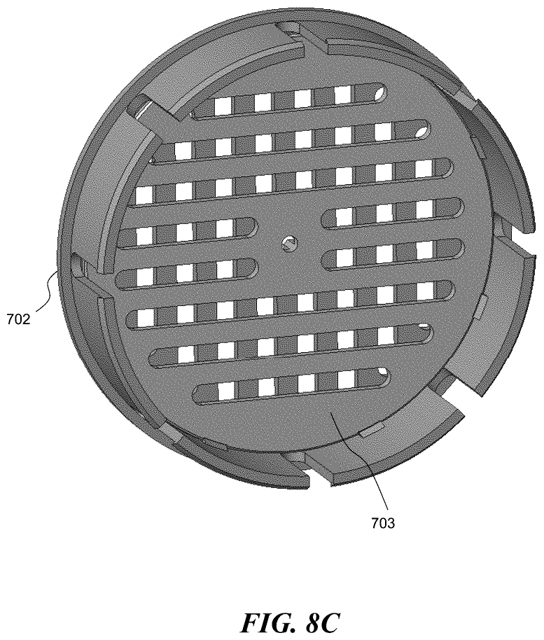

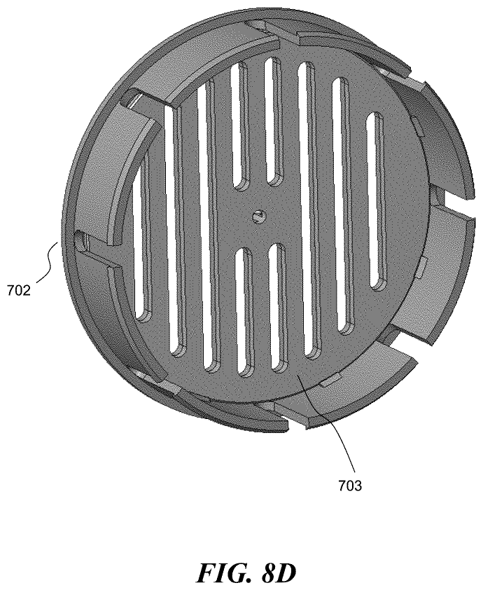

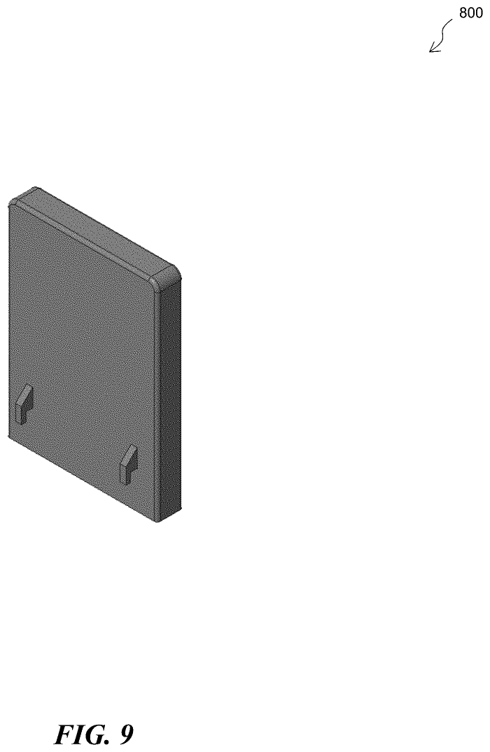

FIG. 7. shows a water storage unit assembly 700 with flow restrictors according to some embodiments of the present disclosure. The water storage unit assembly 700 is similar to the assembly shown in FIG. 3A but including various flow restrictors. The water storage unit assembly 700 includes a water storage lid 200 connected to the top of a water storage unit 100. The assembly 700 further includes two flow restrictor assemblies 701 that have been inserted into and reside within openings 102a and 102b. The flow restrictor assemblies 701 can optionally be placed in the various openings 102 around the water storage unit 100 (not just the side shown in FIG. 7). Such flow restrictor assemblies 701 can add flow restrictions for the purpose of either slowing or redirecting water flow. Additional details with respect to the flow restrictor assemblies 701 are discussed in FIGS. 8A-8D. In addition, the water storage unit assembly 700 includes two secondary flow restrictors 800, which are inserted into and reside within the secondary openings 104a and 104b. Secondary flow restrictors 800 can fully block water flow or direct the water to flow through other openings. Additional details of the secondary flow restrictors 800 are discussed in FIG. 9.

FIG. 8A shows a perspective view of a flow restrictor assembly 701 according to some embodiments of the present disclosure. The flow restrictor assembly 701 includes a casing 702 and an aperture 703 that can be removably attached to the inside of the casing 702. In some embodiments, the aperture 703 is a rotatable aperture. Additional details of the aperture 703 are discussed in relation to FIGS. 8B-8D. In some embodiments, the casing 702 can include snap-in assembly features 704, which allow the flow restrictor assembly 701 to removably connect to (via snapping in) to a water storage unit 100 via an opening 102. In some embodiments, the casing 702 can further include a plurality of slits 705a-h (herein referred to as a “slit 705” generally or “slits 705” collectively). In some embodiments, the slits 705 can be equally spaced around the perimeter of the casing 702. The slits 705 are configured to receive a detent of the aperture 703 (not shown, see FIG. 8B) to facilitate their connection. Although the flow restrictor assembly 701 of FIG. 8A shows eight slits 705, this is not limiting and is merely exemplary in nature. In addition, the casing 702 can include a slot configuration 706. The slot configuration shown in FIG. 8A includes various vertical slots with curved ends, although the actual shape and arrangement of slots may vary based on the desired flow characteristics. In some embodiments, the flow restrictor assembly 701 has a diameter of about 108 mm and a thickness of about 20 mm. In some embodiments, each slot of the slot configuration 706 can have a width of about 5 mm.

FIG. 8B shows an exploded view of a flow restrictor assembly 701 according to some embodiments of the present disclosure. As discussed above, the flow restrictor assembly 701 includes a casing 702 and an aperture 703. In some embodiments, the aperture 703 includes a plurality of detents 707, which are configured to align with and enter the slits 705 of the casing 702 to facilitate their connection. In addition, the aperture 703 has a slot configuration 708. In some embodiments, the slot configuration 708 can be the same configuration as the slot configuration 706 of the casing 702. In addition, the aperture 703 can be rotatable within the casing 702 (see FIGS. 8C-8D below).

FIG. 8C shows a back perspective view of a first configuration of a flow restrictor assembly 701 according to some embodiments of the present disclosure. In this first configuration, the slots of the slot configuration 708 of the aperture 703 are perpendicular to the slots of the slot configuration 706 of the casing 702. This creates the smallest area of opening through the flow restrictor assembly 701 and thus allows the least amount of flow.

FIG. 8D shows a back perspective view of a second configuration of a flow restrictor assembly 701 according to some embodiments of the present disclosure. In this second configuration, the slots of the slot configuration 708 of the aperture 703 are parallel to and overlap the slots of the slot configuration 706 of the casing 702. This creates the largest area of opening through the flow restrictor assembly 701 and thus allows the greatest amount of flow.

In some embodiments, the rotation of the aperture 703 within the casing 702 can be controlled in-situ via a low voltage solenoid control mechanism.

FIG. 9 shows a perspective view of another flow restrictor 800 according to some embodiments of the present disclosure. In some embodiments, the flow restrictor 800 can also be slotted (not shown). The flow restrictor 800 can have a height of about 139 mm, a width of about 101 mm, and a thickness of about 17.5 mm.

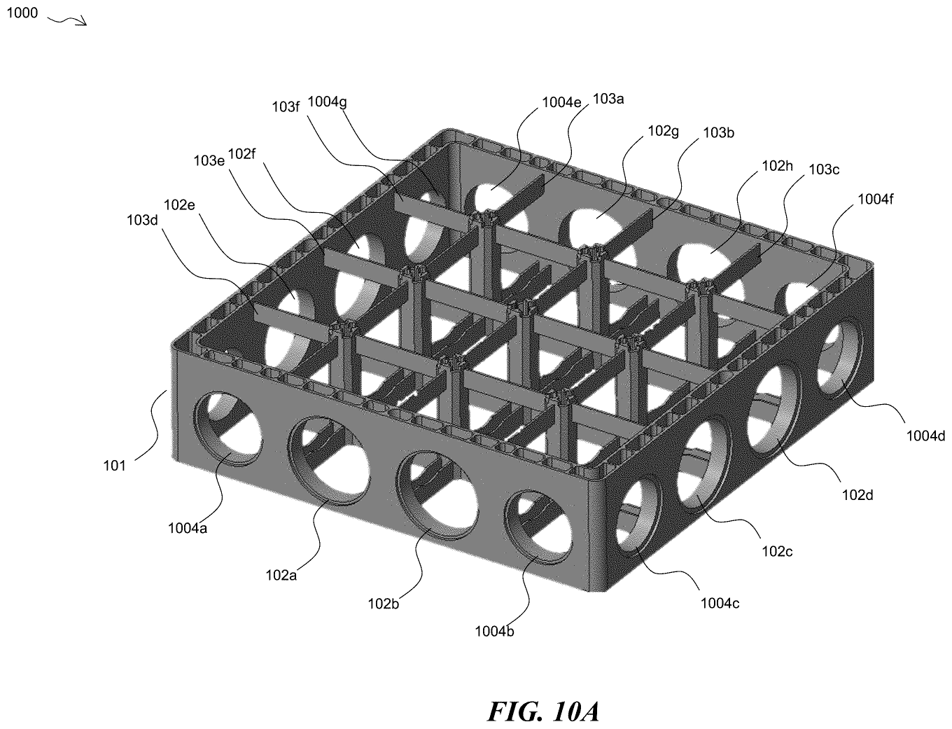

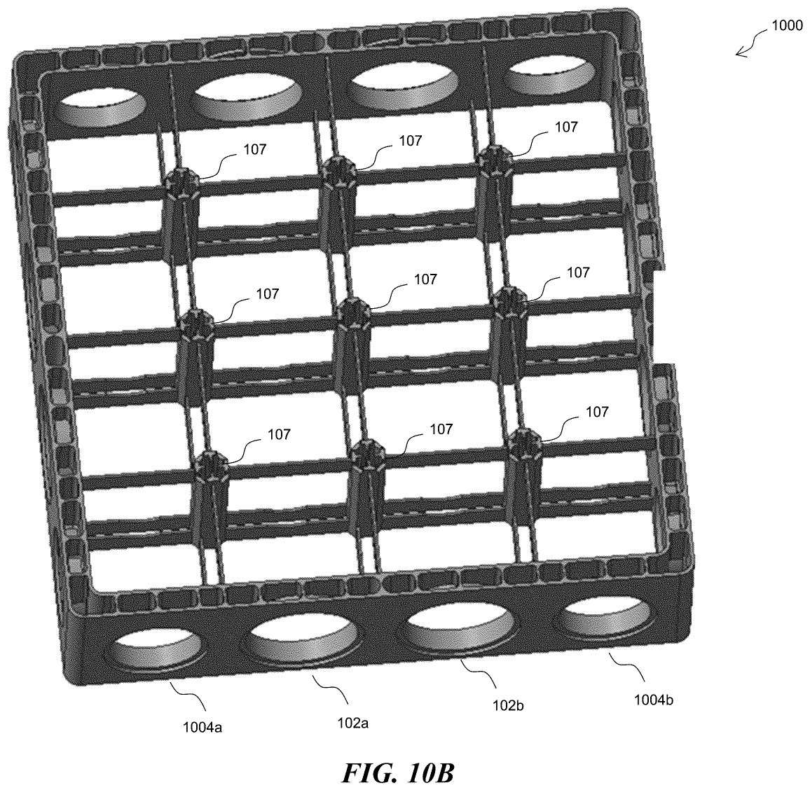

FIG. 10A shows a perspective view of another embodiment of a water storage unit 1000 according to some embodiments of the present disclosure. FIG. 10B shows a top perspective view of another embodiment of a water storage unit 1000 according to some embodiments of the present disclosure. The water storage unit 1000 can be similar to the water storage unit 100 except that the water storage unit 1000 has secondary openings 1004 on each side of the outer shell 101 that are circular in shape. In some embodiments, the diameter of the circular secondary openings 1004 can be about 85-90, such as 89 mm. The secondary openings 1004 can reside between an opening 102 and the nearest corner of the outer shell 101. In addition, similar to the water storage unit 100, the secondary openings 1004 are optional, but may reduce the amount of required material to build the water storage unit 1000 while maintaining sufficient structural integrity to support a hardscape and any weight thereon.

In some embodiments, the diameter of the secondary openings 1004 may be smaller than the diameter of the openings 102, which can preserve the bulkhead material needed to support the loads thereon. However, creating the circular secondary openings 1004 can have risks because a slide in the mold (used to create openings 102) that was extended to the ends of the part could create a significant amount of moving steel on all four sides with some additional challenges to create the shutoff at each intersecting corner.

The use of a much smaller slide to pull the two openings 102 was originally seen as being potentially lower risk than the alternative, which was to have the entire side of the part pull to create four round pass-through holes. This is because the length of the slide and distance of the requisite pulling could exceed the typical expected capacity of the tooling machine. It was then discovered that a single slide can pull all four features (the two secondary openings 1004 and the two openings 102 on a side) without threatening the expected capacity, and therefore four slides can be used for all four sides.

In addition, there are various benefits of circular secondary openings 1004 over rectangular secondary openings 1004. For example, when all openings are circular, it enables greater efficiency in the build environment as virtually all water and utility conveyances are circular. As the system is layered, there are many more options at each layer to run conduit, piping, and other utility services. This enables significant options and flexibility in the system and for each layer to have separate conveyances moving throughout. In addition, circular-shaped openings allow for simpler connections with pipes without the need to fill any additional holes or open areas that may be left by threading a pip through a rectangular opening. The water flow is therefore more efficient as water conveyances are generally circular.

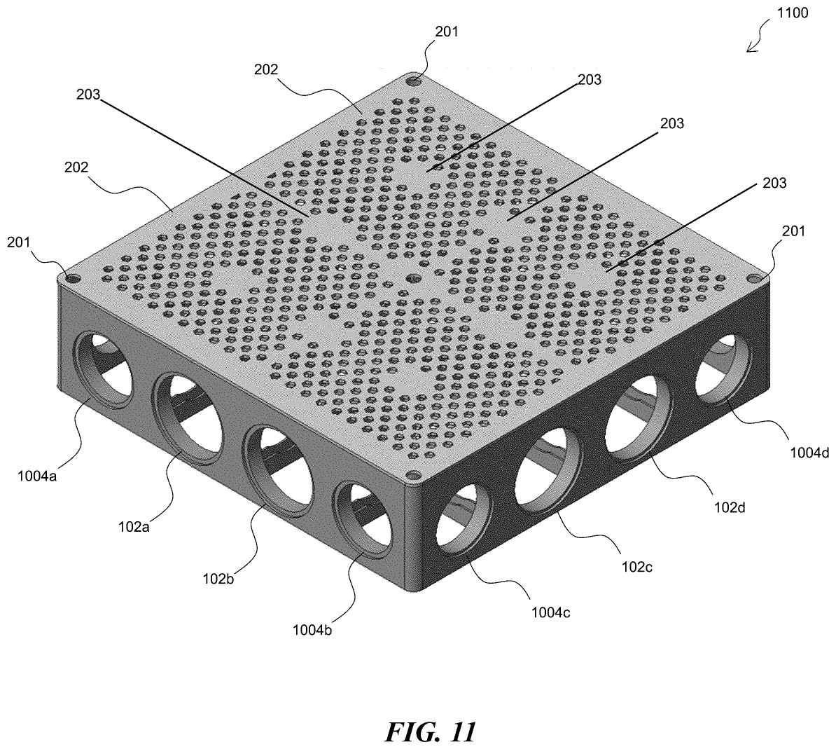

FIG. 11 shows a perspective view of another embodiment of a water storage unit and lid combination 1100 according to some embodiments of the present disclosure. The combination 1100 can be similar to the combination 300 of FIG. 3A, except that it includes a water storage unit 1000 attached to a water storage lid 200.

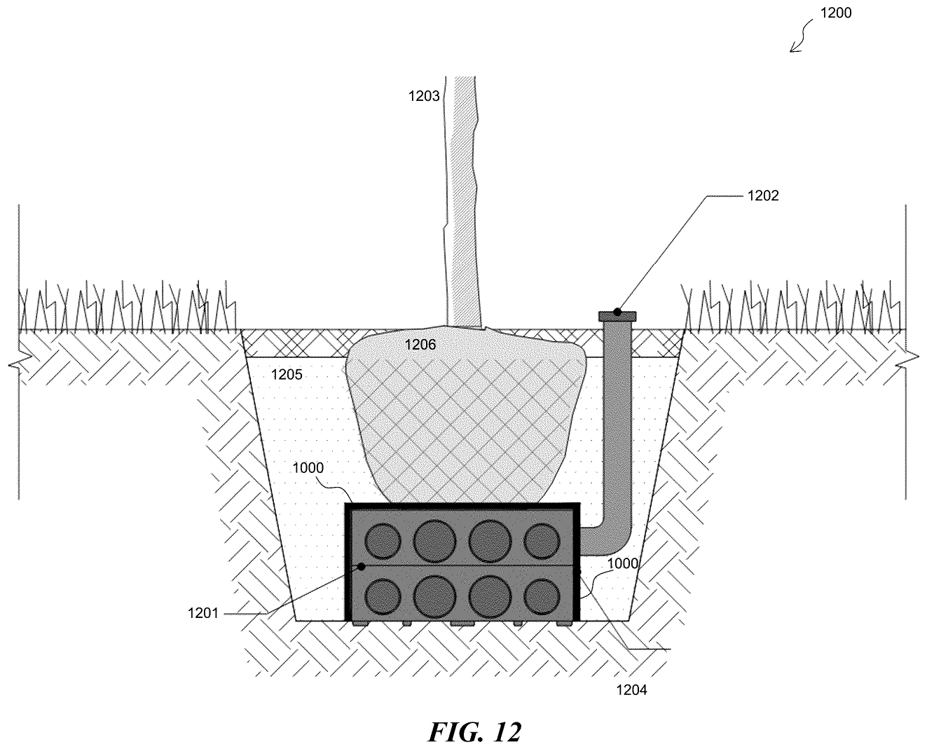

FIG. 12 shows an example tree watering system 1200 according to some embodiments of the present disclosure. The system 1200 can be used to facilitate the watering of a tree, although the present disclosure is not limited to trees and various other types of vegetation can be watered. The tree includes a trunk 1203 and a root ball 1206 surrounded by soil 1205, which can be bio-retention soil. The system 1200 can include a storage system 1201 that comprises a plurality of storage units 1000 (see FIGS. 10A-10B). It is important to note that, while the storage system 1201 comprises storage units 1000, the storage system 1201 according to the present disclosure can also include storage units 100. Moreover, while the storage system 1201 in FIG. 12 has two storage units 1000, the disclosure is not so limited and any number of storage units 1000 can be employed. In some embodiments, the plurality of storage units 1000 can be vertically stacked. In some embodiments, each of the storage units 1000 can be wrapped in a geotextile material, which can ensure effective water saturation in the soil 1205. The geotextile material can also preserve the functionality of the system and prolong its lifespan and effectiveness. Moreover, the geotextile material can facilitate water permeation while preventing soil ingress.

In addition, the watering system 1200 can include a fill tube 1202. In some embodiments, the fill tube 1202 can be the primary conduit for water delivery to the storage system 1201. In some embodiments, a first end of the fill tube 1202 can reside above the ground surface level while the second end of the fill tube 1202 can rest within an opening of a storage unit 1000. Such a fill tube 1202 can offer flexibility in water sources to accommodate different environmental conditions and climates. In some embodiments, the fill tube 1202 can be connected to a rainwater harvesting system, conventional hoses, or alternate irrigation setups.

Within the watering system 1200, water and air can be efficiently transferred to the tree root ball 1206. Such a simultaneous delivery can ensure sufficient hydration and aeration, assisting with healthy root development and overall tree vigor. In addition, planting the tree 1203 directly above the storage system 1201 can provide support and prevent subsidence, enabling the tree to maintain its grade position and match above ground grade level. In some embodiments, the storage system 1201 can also provide windthrow protection and support by utilizing various support kits.

In some embodiments, the watering system 1200 can be enhanced via the incorporation of one or more soil moisture sensors. For example, such sensors can enable real-time monitoring of soil moisture levels in the vicinity of the tree root ball 1206. Moreover, by interfacing with the system, the sensors can provide valuable feedback on the soil moisture conditions which can allow for precise and efficient irrigation management. In some embodiments, soil moisture data obtained from the sensors can be used to automate irrigation schedules, which can ensure that water is applied as necessary, thus preventing overwatering and conserving water resources. Finally, the incorporation of soil moisture sensors can enhance the adaptability of the system to varying environmental conditions, such as changes in rainfall patterns or soil moisture retention capacity.

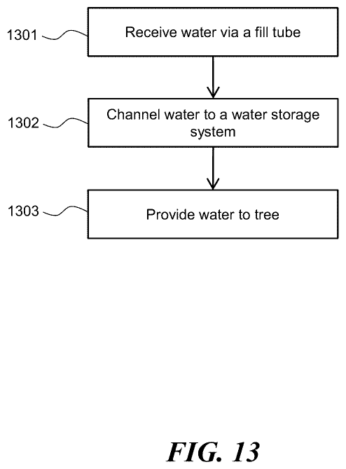

FIG. 13 shows an example tree watering process 1300 according to some embodiments of the present disclosure. In some embodiments, the tree watering process 1300 can be performed using the watering system 1200 of FIG. 12. At block 1301, the process 1300 can include receiving water via the fill tube 1202. In some embodiments, receiving the water can include receiving the water from one or more of a rainwater harvesting system, conventional hoses, or alternate irrigation setups. At block 1302, the process 1300 can include, via the fill tube 1202, channeling the received water to the water storage system 1201 which, as discussed above, can include various storage units 1000. At block 1303, the process 1300 can include providing water from within the water storage system 1201 to the tree root ball 1206.

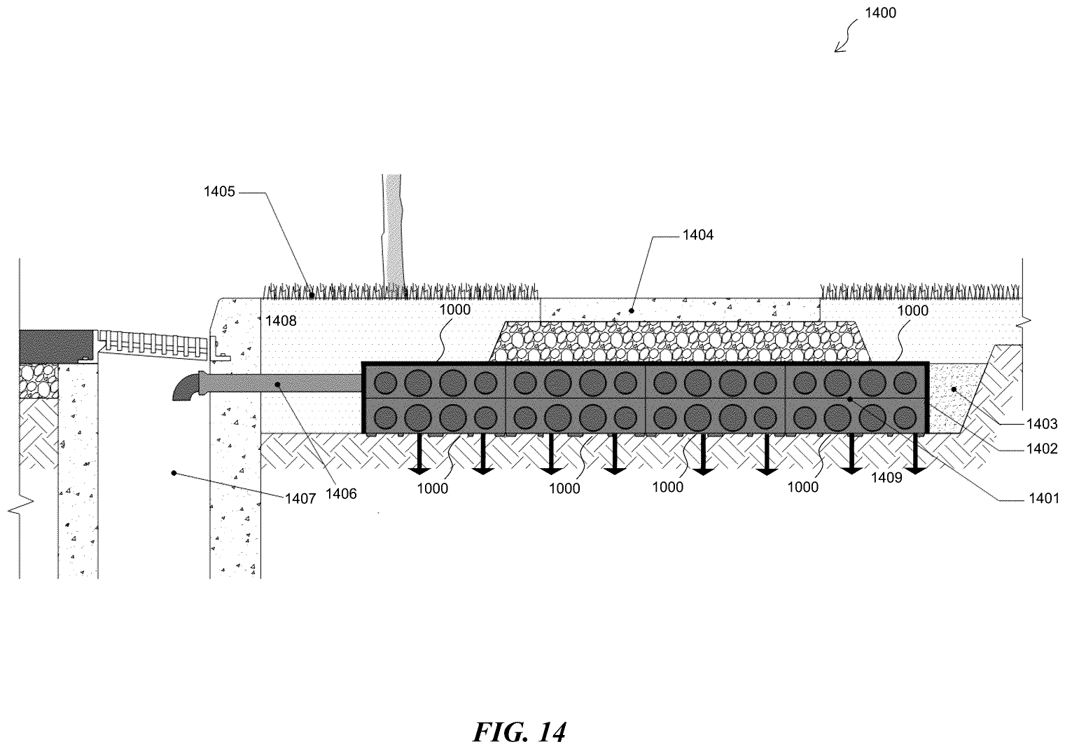

FIG. 14 shows an example drainage system 1400 according to some embodiments of the present disclosure. The drainage system 1400 can be used to facilitate the drainage of water from beneath a sidewalk 1404 and a grass boulevard 1405. The sidewalk 1404 can reside on top of an aggregate base course that provides support for the sidewalk 1404, which rests on top of the drainage configuration 1401. In some embodiments, the concrete of in lieu of the aggregate base course can be poured directly on top of the configuration 1401 with only a layer of geotextile to prevent the concrete from entering the system. The configuration 1401 can be surrounded by soil 1408 (e.g., bio-retention soil) and a compacted backfill 1403. Moreover, the configuration 1401 can include a plurality of storage units 1000. It is important to note that, while the drainage configuration 1401 comprises storage units 1000, the drainage configuration 1401 according to the present disclosure can also include storage units 100. Moreover, while the drainage configuration 1401 in FIG. 14 has eight storage units 1000, the disclosure is not so limited and any number of storage units 1000 can be employed. In some embodiments, the plurality of storage units 1000 can be stacked both vertically and horizontally (e.g., a 2×4 configuration). In some embodiments, each of the storage units 1000 can be wrapped in a geotextile material, which can ensure effective water saturation in the 1408. The geotextile material can also preserve the functionality of the system and prolong its lifespan and effectiveness. Moreover, the geotextile material can facilitate water permeation while preventing soil ingress.

In addition, the drainage system 1400 can be integrated with an inlet pipe 1406 and a catch basin 1407. The inlet pipe 1406 and the catch basin 1407 can be configured to capture and redirect stormwater runoff from the drainage configuration 1401. For example, one end of the inlet pipe 1406 can reside within a primary or secondary opening within a storage unit 1000, and the other end can drain water to the catch basin. Additionally, the drainage system 1400 can promote the infiltration of water directly below the configuration 1401 into the soil as indicated by the arrows in FIG. 14. This can allow for the on-site capture and retention and the replenishment of underground aquifers.

The drainage system 1400 can provide various benefits. First, the drainage system 1400 can allow for captured stormwater to be managed onsite, which enables its infiltration into the ground or reuse for irrigation purposes. Second, by facilitating onsite stormwater management, the drainage system 1400 can aid in meeting post-development stormwater regulations and goals and contribute to sustainable development practices. Third, the shallow nature of the drainage system 1400 can reduce excavation requirements and enable cost effective installation while increasing the utilization of available space for storage and reuse purposes.

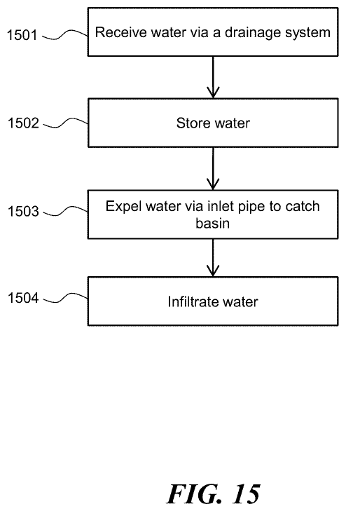

FIG. 15 shows an example drainage process 1500 according to some embodiments of the present disclosure. In some embodiments, the tree watering process 1500 can be performed using the watering system 1400 of FIG. 14. At block 1501, the process 1500 can include receiving water via the drainage system 1400. In some embodiments, the drainage system 1400 can receive stormwater that flows through the grass boulevard 1405 and the sidewalk 1404 via the configuration 1401. At block 1502, the process 1500 can include storing the water via the configuration 1401. For example, the collected water can reside within the various water storage units 1000. At block 1503, the process 1500 can include expelling water via the inlet pipe 1406 to the catch basin 1407. At block 1504, the process 1500 can include infiltrating water into the soil beneath the configuration 1401, which can promote on-site capture and retention and the replenishment of underground aquifers.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A watering system for watering a tree comprising:
one or more vertically stacked water storage units, each storage unit comprising an outer shell with a first side comprising a first plurality of openings and a second side adjacent the first side comprising a second plurality of openings, wherein a top water storage unit comprises a water storage lid, wherein at least one of the first side or second side comprises a plurality of secondary openings, wherein each secondary opening is between an opening and a corner of the outer shell; and
a fill tube comprising a first end and a second end, the first end residing above a ground level and the second end residing in an opening of the first or second plurality of openings of a water storage unit;
wherein the fill tube is configured to feed water into the one or more water storage units;
wherein the tree resides on top of the one or more vertically stacked water storage units.

2. The water storage system of claim 1, wherein the outer shell comprises:
a third side comprising a third plurality of openings, wherein the third side is opposite the first side and the third plurality of openings are aligned with the first plurality of openings; and
a fourth side comprising a fourth plurality of openings, wherein the fourth side is opposite the second side and the fourth plurality of openings are aligned with the second plurality of openings.

3. The water storage system of claim 1, wherein a root ball of the tree resides on top of the one or more vertically stacked water storage units.

4. The water storage system of claim 1, wherein the one or more vertically stacked water storage units comprise two water storage units.

5. The water storage system of claim 1, wherein the one or more vertically stacked water storage units are wrapped in a geotextile material.

6. The water storage system of claim 1, wherein the one or more vertically stacked water storage units are surrounded by bio-retention soil.

7. The water storage system of claim 1, wherein the fill tube is connected to and receives water from at least one of a rainwater harvesting system, a hose, or an irrigation system.

8. The water storage system of claim 1, wherein the watering system comprises one or more soil moisture sensors configured to measure moisture levels of soil surrounding the one or more water storage units.

9. The water storage system of claim 1, wherein each water storage unit comprises:
a first set of cross-bodies spanning a width of the outer shell; and
a second set of cross-bodies spanning a length of the outer shell and intersecting the first set of cross-bodies.

10. The water storage system of claim 9, wherein each water storage unit comprises a plurality of vertical pillars, the pillars supporting intersection points of the first and second sets of cross-bodies.

11. A drainage system comprising:
a one or more water storage units, each storage unit comprising an outer shell with a first side comprising a first plurality of openings and a second side adjacent the first side comprising a second plurality of openings, wherein a top water storage unit comprises a water storage lid, wherein at least one of the first side or second side comprises a plurality of secondary openings, wherein each secondary opening is between an opening and a corner of the outer shell;
a catch basin; and
an inlet pipe comprising a first end and a second end, the first end residing in an opening of the first or second plurality of openings of a water storage unit and the second end being positioned to redirect water from the plurality of water storage units to the catch basin;
wherein the plurality of water storage units reside underneath a hardscape.

12. The drainage system of claim 11, wherein the outer shell comprises:
a third side comprising a third plurality of openings, wherein the third side is opposite the first side and the third plurality of openings are aligned with the first plurality of openings; and
a fourth side comprising a fourth plurality of openings, wherein the fourth side is opposite the second side and the fourth plurality of openings are aligned with the second plurality of openings.

13. The drainage system of claim 11, wherein the one or more water storage units comprise a plurality of stacks of water storage units.

14. The drainage system of claim 13, wherein each stack of water storage units comprises two vertically stacked water storage units.

15. The drainage system of claim 11, wherein the one or more water storage units are wrapped in a geotextile material.

16. The drainage system of claim 11, wherein the one or more water storage units are surrounded by bio-retention soil and a compact backfill.

17. The drainage system of claim 11, wherein the watering system comprises one or more soil moisture sensors configured to measure moisture levels of soil surrounding the one or more water storage units.

18. The drainage system of claim 11, wherein each water storage unit comprises:
a first set of cross-bodies spanning a width of the outer shell; and
a second set of cross-bodies spanning a length of the outer shell and intersecting the first set of cross-bodies.

19. The drainage system of claim 18, wherein each water storage unit comprises a plurality of vertical pillars, the pillars supporting intersection points of the first and second sets of cross-bodies.
